(19) United States
(12) Patent Application Publication
(10) Pub. No.: US 2021/0230813 A1
(43) Pub. Date: Jul. 29, 2021

(54) ELASTIC LAYERS WITH FIBERS

(71) Applicants: APT Advanced Polymer Technology Corp., Harmony, PA (US); Polytex Sportbelage Produktions-GmbH, Grefrath (DE)

(72) Inventors: Stephan Sick, Willich-Neersen (DE); Kris Brown, Dalton, GA (US); lvo Lohr, Kempen (DE); Stefan Hally, Nettetal (DE)

(73) Assignees: APT Advanced Polymer Technology Corp., Harmony, PA (US); Polytex Sportbelage Produktions-GmbH, Grefrath (DE)

(21) Appl. No.: 16/751,763

(22) Filed: Jan. 24, 2020

(51) Int. Cl. E01C 13/08; B29C 39/00

(52) U.S. Cl. CPC E01C 13/08; B29L 2031/732; B29C 39/003

(57) ABSTRACT

The invention relates to an elastic layer (202) for use as a support layer of sports floor (302), the elastic layer being made of a mixture of fibers (206), elastic granules (208), and a binder (204).

### FIELD OF THE INVENTION

The invention relates to elastic layers—in particular, elastic layers providing support for a sports floor.

### BACKGROUND AND RELATED ART

Sports floors such as artificial turf, playground floors or other types of floors used in leisure time facilities typically are elastic and have some shock absorbing properties. A broad variety of sports floors exists.

Artificial turf or artificial grass is surface that is made up of fibers, and is used to replace real grass. The structure of the artificial turf is designed such that the artificial turf has an appearance that resembles grass. Typically, artificial turf is used as a surface for sports such as soccer, football, rugby, tennis, and golf, and for playing fields and exercise fields. Furthermore, artificial turf is frequently used for landscaping applications.

Artificial turf may be manufactured using techniques for manufacturing carpets. For example, artificial turf fibers, which have the appearance of grass blades, may be tufted or otherwise integrated into a carrier. Often, artificial turf infill is placed between the artificial turf fibers. Artificial turf infill is a granular material that covers the bottom portion of the artificial turf fibers.

Sometimes, artificial turf is perceived as being insufficiently “bouncy” if the elasticity of the artificial turf is not sufficient to allow a ball to bounce back quickly. Moreover, artificial turf is sometimes perceived as insufficiently elastic to effectively protect the joints of the players from injury. Hence, the artificial turf is sometimes installed on top of an elastic layer. For example, US 2006/0084513 A1 (De Vries et al.) discloses a method for laying a playing field comprising a layer of a resilient and/or damping material and a top layer arranged on the resilient layer. The top layer may be a synthetic turf.

International patent application WO 2009/118388 A1 describes the forming of an elastic layer (e-layer) by mixing polymer granules with a polyurethane binder.

### SUMMARY

The invention provides for an elastic layer (alternately “e-layer” and “elastic layer” throughout), for a flooring structure comprising the same, and for a method of manufacturing the elastic layer as specified in the independent claims. Embodiments are given in the dependent claims. Embodiments and examples described herein can freely be combined if they are not mutually exclusive.

In one aspect, the invention relates to an elastic layer for use as a support layer for a sports floor. The elastic layer is made from a mixture of fibers, elastic granules, and a binder.

This may be advantageous, because the fibers have a much higher surface-to-mass ratio than, for example, the rubber granules, and hence provide for an e-layer with a higher tensile strength than elastic layers merely comprising elastic granules do. The fibers connect different regions of the e-layer with each other and provide for a homogeneous distribution of any impacting force across a large surface area. For example, the force of the impact of a ball or the force of a player's foot during sudden braking or change of direction is distributed by the fibers within the elastic layer over a comparatively large area. This reduces the wear and tear of the elastic layer (and the sports floor lying on top of it), protects the players from injuries, and improves the movement behavior of the ball.

The protective effect of the fibers is particularly beneficial in temperate climate zones in which many freeze-thaw cycles are observed each year. This is because the frequent freeze-thaw cycles damage the stone substrate onto which the elastic layer and/or the sports floor is placed. Larger cracks and holes are created by water that has managed to penetrate the base layer, because when water freezes to ice, it has a larger volume and may thus burst even concrete or stone over the years. If a ball hits a sports floor that has been laid on an uneven base layer with larger cracks or holes, or if the base layer has aged over many years after the sports floor has been installed at the use site, the ball can damage the elastic layer and/or the sports floor at places that lie above such a hole. With the placement of the sports floor on top of an e-layer comprising fibers, this damage can be prevented, because the fibers in the e-layer ensure that the e-layer has a high tensile strength and that any impacting force is distributed over a comparatively large area, thereby significantly reducing the force per square centimeter and the risk of damaging the sports floor if the force is applied on a sports floor area that covers a large crack or hole.

According to embodiments, the elastic granules are rubber granules—in particular, styrene-butadiene rubber (SBR) granules and/or ethylene propylene diene monomer (EPDM) rubber granules.

This may be beneficial, because the elasticity provided by the rubber granules protects the joints of the players from injury. In addition, the increased elasticity of the ground allows the ball to bounce back farther and faster.

According to embodiments, the fibers are non-stretchable.

This may be beneficial, because non-stretchable fibers provide for an e-layer with particularly high tensile strength. For example, many synthetic fibers like nylon are basically non-stretchable at room temperatures.

According to embodiments, the fibers have a random orientation within the binder.

This may be beneficial, because the tensile strength of the e-layer is increased in all directions of the e-layer.

According to embodiments, the fibers have a length of at least 1 cm. Preferably, the fibers have a length of at least 2 cm.

This may be beneficial, because fibers shorter than 1 cm have been observed to provide only a comparatively low increase in the tensile strength.

According to embodiments, more than 60% of the fibers have a length of 1-5 cm, preferably 3-4 cm.

This may be beneficial, because fibers whose length is within this range have been observed to provide an e-layer with high tensile strength. Fibers of even greater length may not significantly further improve the tensile strength, because they may exceed the dimensions of the e-layer in at least one direction (the vertical direction) and/or because at a length of about 3-4 cm, the fibers will basically span the entirety of the e-layers in all directions such that no significant volume in the e-layer is free of the fibers.

According to embodiments, the fibers have different lengths.

For example, the fibers can comprise fibers whose lengths are in the range of 0.5-1.5 cm and fibers whose lengths are in the range of 3-5 cm.

As another example, the fibers can comprise fibers whose lengths are basically identical to the height of the e-layer +/−10% and can fibers whose lengths are more than twice the height of the e-layer.

According to embodiments, the height of the e-layer is at least 6 mm, preferably at least 9 mm. However, the height of the e-layer may depend on the intended use of the floor structure comprising the e-layer. For example, the height of an e-layer of an artificial turf that is to be used for soccer is preferably about 20 mm to 35 mm. To the contrary, the height of an e-layer of an artificial turf that is to be used for a golf court is preferably about 10 mm to 15 mm.

According to embodiments of the invention, the height of the e-layer is in the range of 8 mm-40 mm, in particular 10-35 mm, in particular 20-35 mm.

As another example, the length difference between the maximum or average length of the shortest 10% of the fibers and the maximum or, respectively, average length of the longest 10% of the fibers can be at least 3 cm, e.g., at least 4 cm.

This may be advantageous, because the small fibers can be oriented freely and randomly in all directions, including the vertical direction, thereby also increasing the tensile strength in that vertical direction. If only long fibers would be added to the mixture used for providing the e-layer, these fibers would be forced to adopt a horizontal orientation, e.g., from left to right or vice versa, or from front to back or vice versa, but not a vertical one because the height of the e-layer may be less than the length of the fiber. The long fibers significantly increase the tensile strength of the e-layer, but may not all be oriented randomly within the e-layer because their length may be greater than the height of the e-layer. Hence, a combination of short and long fibers may be particularly advantageous as the combination may ensure a random orientation of at least a fraction of the fibers and at the same time a significant increase in the tensile strength of the e-layer, in particular in a horizontal direction.

According to embodiments, the fibers are plant fibers. For example, the plant fibers can be jute fibers, hemp fibers, flax fibers, bamboo fibers, kapok fibers, corn silk fibers, sisal fibers, coconut fibers, cotton fibers, cellulose fibers, or mixtures thereof.

This may be advantageous as plant fibers are typically cheap and biodegradable. Hence, an environmentally friendly and cheap fiber type may provide for an e-layer whose CO₂ footprint is smaller than that of conventional e-layers for artificial turf.

According to other embodiments, the fibers are synthetic fibers. The synthetic fibers can be, for example, polyethylene fibers, polyamide fibers, polypropylene fibers, nylon fibers, polyester fibers, glass fibers, fibers made of rubber (e.g. Ethylen-Propylen-Dien (EPDM) rubber, Styrene Butadiene Rubber (SBR)), or mixtures thereof.

According to other embodiments, the fibers are mixtures of plant fibers and synthetic fibers.

According to embodiments, the synthetic fibers comprise a nucleating agent.

For example, the nucleating agent can be an inorganic substance (e.g., talcum, kaolin, calcium carbonate, magnesium carbonate, silicate, silicic acid, silicic acid ester, aluminum trihydrate, magnesium hydroxide, meta- and/or polyphosphates, and coal fly ash). According to other examples, the nucleating agent is an organic substance (e.g., 1,2-cyclohexane dicarbonic acid salt, benzoic acid, benzoic acid salt, sorbic acid, or sorbic acid salt).

This may be advantageous, because the nucleating agent can increase the surface roughness of synthetic fibers, thereby strengthening the adhesion of the binder to the fiber surface. This may improve the homogeneous spreading of impacting forces over a larger area of the e-layer.

According to embodiments, the synthetic fibers comprise unaged (i.e., newly produced) or aged (i.e., used) artificial turf fibers or artificial turf fiber fragments. The unaged artificial turf fibers are preferably production waste (e.g., fibers whose color or profile does not fulfill the requirements of a customer or of the manufacturer).

This may be beneficial as the generated e-layer is more environmentally friendly than state-of-the-art e-layers. This is because production waste generated during the manufacturing of artificial turf fibers can be used to produce the e-layer or because old, worn artificial turf fibers are reused and hence recycled as components of an e-layer.

According to embodiments, the fibers are a mixture of plant fibers and synthetic fibers. This may allow using environmentally friendly plant fibers as far as technically and/or economically possible and supplementing the plant fibers with at least a small fraction of synthetic fibers, which may be more robust against biodegradation than plant fibers are.

According to embodiments, the binder is a polyurethane (“PU”) binder.

In a further aspect, the invention relates to a floor structure comprising the elastic layer of any one of the embodiments and examples described herein. The floor structure further comprises the sports floor. The sports floor is placed on top of the elastic layer.

In a further aspect, the invention relates to a method of manufacturing an elastic layer for use as a support layer of sports floor. The method comprises providing a liquid mixture comprising fibers, elastic granules, and a liquid binder.

The sports floor can be, for example, artificial turf or a playground floor or a floor of a recreational facility. The sports floor can be, according to other examples, a foamed or non-foamed PU layer. According to some embodiments, the sports floor is a layer of sand, infill, clay or other loose material. According to some embodiments, the sports floor has a height of at least 1 cm, preferably at least 2 cm. According to still further embodiments, the sports floor is a thin material layer of less than 0.5 cm, e.g. less than 1 mm, e.g. a coating layer, so the elasticity and other relevant parameters of a sports floor is largely provided by the elastic layer itself.

According to some embodiments, the method further comprises applying the liquid mixture onto a base layer and allowing the mixture to solidify. The solidification can be the result of the binding of the binder (e.g., the curing of a PU reaction mixture used as the binder). According to other embodiments, the method further comprises filling the liquid mixture into one or more molds, allowing the binder to bind, thereby causing the mixture to solidify in the one or more molds, thereby creating tiles which can be laid on a base layer at the use site.

In some embodiments, allowing the mixture to harden involves leaving it at a temperature of about 15-25° C. for one or more hours. In addition, or alternatively, allowing the binder to bind involves heating the mixture to increase the speed of the PU-generating reaction and the solidification. For example, the mixture may be heated to above 50° C. In particular, in case the e-layer is produced in a manufacturing plant, the e-layer may be fabricated in tile-shaped molds which can optionally be heated to increase the solidification speed. When the e-layer tiles in the molds have solidified, they are removed from the molds and transported to the use site, where they are laid to provide the e-layer.

The base layer can be, for example, soil, sand, concrete, or mixtures thereof. The base layer can likewise be wood or an existing floor pavement. The base layer can be an indoor or outdoor base layer. Typically, the base layer is an outdoor base layer.

The e-layer can be applied in situ (e.g., by generating a liquid mixture of the elastic granules, the fibers, and the binder at the use site a short time (within 1 hour or less) before the liquid mixture is applied onto the base layer). The liquid mixture has self-leveling capabilities and may optionally be leveled actively with the help of a leveling device.

Alternatively, the e-layer is manufactured at a manufacturing plant (e.g., in the form of e-layer rolls or tiles). The rolls or tiles are transported to the use site and laid on the base layer of that use site. Preferably, the e-layer tracks generated by the e-layer rolls and the e-layer tiles are attached to the base layer. For example, the e-layer roll or the e-layer tiles are glued, tacked, nailed, or otherwise fixed to the base layer.

In a further aspect, the invention relates to a method of installing a sports floor. The method comprises manufacturing the elastic layer in accordance with embodiments of the invention described herein. Then, a sports floor layer is placed on top of the elastic layer.

Optionally, the sports floor is glued, nailed, tacked, or otherwise fixed onto the e-layer. This may prevent the sports floor from being moved relative to the e-layer.

Preferably, the sports floor is applied onto the e-layer after the e-layer has solidified, as this eases the application, fitting, and handling of the sports floor. However, in some embodiments, the sports floor is applied before the e-layer has completely solidified.

The term “elasticity” as used herein refers to the ability of a material to recover its original dimensions, and to return to its original shape, after being subjected to a stress. Solid objects will deform when adequate forces are applied to them. If the material is elastic, the object will return to its initial shape and size when these forces are removed.

Preferably, the elastic layer is an area-elastic layer. The elastic layer can be, for example, a self-leveling, in-situ created layer composed of an elastic granulate, a binder and further substances.

According to embodiments, the e-layer is adapted for use as a sports ground or playground. According to embodiments, the e-layer has mechanical parameter values, e.g. in respect to shock absorption capacity, rigidity, and/or elasticity, which are adapted for protecting players from injuries when using the floor comprising the e-layer as a sports ground or playground. Preferably, the e-layer has mechanical parameter values which are adapted for protecting players from injuries even in case the sports ground or playground does not comprise any additional elastic layers or an elastic substrate, meaning that the e-layer is basically the only layer adapted to protect the players from injuries. The sportsground can be a sportsground selected from a group comprising: a baseball ground, a tennis court, a handball ground, a hockey ground, a running track, and a Football ground.

According to embodiments, the e-layer has a shock absorption (measured at 23° C.) of at least 55%, preferably at least 65%. For example, the e-layer has a shock absorption of 55-70%. The shock absorption can be measured in accordance with the testing method detailed in the FIFA Handbook of Tests Methods for Football Turf 2015 (in particular sections 4 and 11).

According to embodiments, the e-layer has a vertical deformation of 4 mm-11 mm as a result of an impact of a 20 kg mass measured at 23° C. in accordance with the testing method detailed in the FIFA Handbook of Tests Methods for Football Turf 2015.

An “e-layer” can be, for example, a layer that has a shock absorption (measured at 23° C.) of at least 55% and a vertical deformation of at least 4 mm, preferably at least 6mm, measured at 23° C. in accordance with the testing method detailed in the FIFA Handbook of Tests Methods for Football Turf 2015.

According to one embodiment, the “e-layer” is a layer that has a Head Injury Criteria (HIC) of less than 1000. For example, this type of e-layer can be used as a rugby sports floor. According to some embodiments, the e-layer is a layer that has a HIC of less than 200. For example, this type of e-layer can be used as a playground.

The testing for the HIC value of a surface or layer and for the related “critical height” of said surface or layer is typically done in a laboratory, however, testing may also be done in the field using the F1292 testing methodology. The ASTM International (ASTM) Standard F1292 is designed to provide a testing method for surfacing materials that will allow assessment of impact attenuation of playground surfacing and thus reduce the severity and frequency of fall-related head injuries.

The shock or force of the impact of an object on a surface can be measured in “g's” which is the acceleration due to gravity. The maximum peak deceleration before a debilitating head injury might occur is 200 g's. HIC, Head Injury Criteria, measures the time of deceleration. The value of the HIC must be less than 1000 to avoid a life-threatening head injury.

A “critical height” of a surface is a physical property of a surface or layer that is defined as the maximum fall height from which a life-threatening head injury would not be expected to occur”. Fall height is defined as the vertical distance between a designated play surface and the playground surface beneath it. Fall heights of various kinds of play equipment are identified in the U.S. Consumer Product Safety Commission (CPSC) publication “Public Playground Safety Handbook” in Section 5 under each type of equipment. Critical height is determined by a combined measurement of acceleration (shock) of an impact and the duration of the impact as it relates to head injury.

A “non-stretchable” material as used herein is a material that does not increase its length significantly if a pulling force of about 50 Newtons at about 20° C. is applied. For example, a non-stretchable material can be a material that does not increase its length by more than 5% if a pulling force of about 50 Newtons at about 20° C. is applied. Hence, a non-stretchable material is a material that basically does not extend if subjected to this pulling force.

A “nucleating agent” as used herein is a substance that promotes the crystallization of semi-crystalline polymers. These substances function by presenting a heterogeneous surface to the polymer melt, making the crystallization process more thermodynamically favorable. As a result of this effect, the temperature at which the polymer begins to crystallize from the melt is increased, as are the rate of nucleation and overall rate of crystallization.

It is understood that one or more of the aforementioned embodiments of the invention may be combined as long as the combined embodiments are not mutually exclusive.

### BRIEF DESCRIPTION OF THE DRAWINGS

The following embodiments of the invention are explained in greater detail, by way of example only, making reference to the drawings:

FIG. 1 is a flow chart of a method of manufacturing an e-layer;

FIG. 2 is a schematic, a cross-sectional view of an e-layer;

FIG. 3 is a schematic, a cross-sectional view of a pavement structure comprising an e-layer and an artificial turf layer used as the sports floor;

FIG. 4 is a schematic, cross-sectional view of a pavement structure comprising an e-layer and an artificial turf layer comprising a filler; and

FIG. 5 illustrates the installation of multiple e-layer tiles providing a support layer for artificial turf.

### DETAILED DESCRIPTION

Like-numbered elements in these figures either are equivalent elements or perform the same function. Elements that have been discussed previously will not necessarily be discussed in later figures if the function is equivalent.

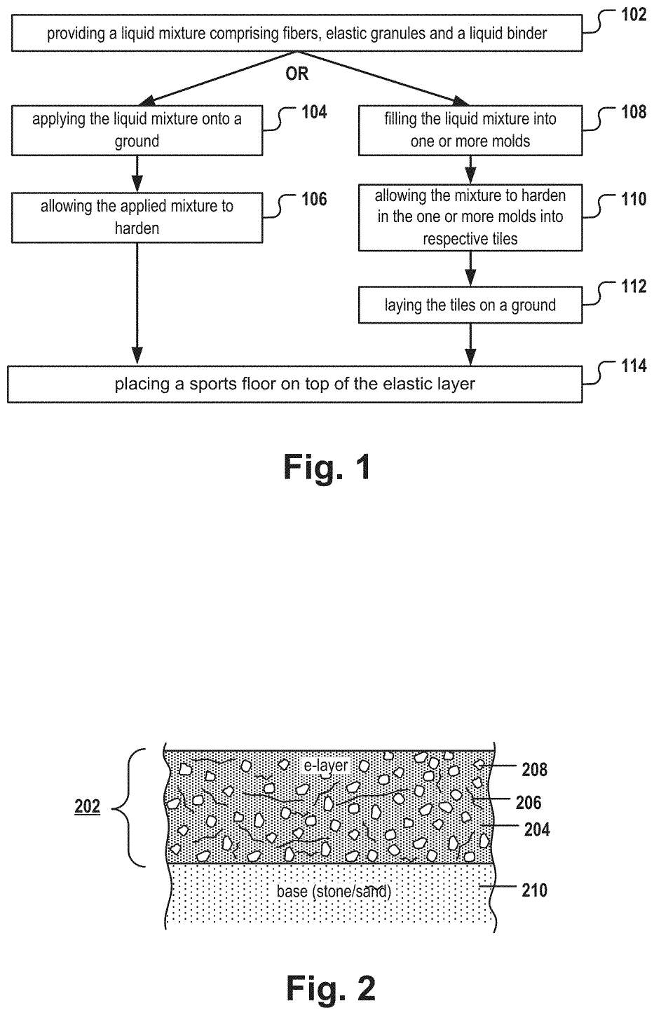

FIG. 1 is a flow chart of a method of manufacturing an e-layer (202). The e-layer is designed and adapted for use as a support layer of a sports floor, e.g. of an artificial turf (302). The method comprises a step 102 of providing a liquid mixture. The mixture comprises fibers 206, elastic granules 208 and a liquid binder 204. For example, the mixture can be created manually or automatically (e.g., by a stirring device). The mixture is mixed until the granules, the fibers, and the binder are homogeneously mixed. Depending on the particular composition of the mixture, this may take 2-20 minutes. The greater the amount of elastic granules, the higher the elasticity of the e-layer. The greater the amount of fibers, the higher the tensile strength of the e-layer.

Typically, the liquid mixture is a highly viscous mixture.

According to embodiments, 0.5% to 40%, more preferentially 5% to 20%, in particular 5% to 10% by weight of the mixture consist of the fibers.

According to embodiments, the weight ration of the binder to the total weight of the elastic granules and the fibers combined is in the range of 5:100 to 15:100, more preferably 8:100 to 10:100. For instance, 8 kg of the binder can be mixed with 100 kg of a fiber-granule mixture. In one example, about 25% of the fiber-granule mixture consist of the fibers and about 75% of the fiber-granule mixture consist of the elastic granules.

According to some embodiments, the artificial turf fibers are made of polyethylene that has been obtained from an old, worn-out artificial turf. The binder can be a polyurethane binder. The elastic granules can be SBR or EPDM rubber granules or other types of granular, elastic material. The SBR rubber granules can be obtained, for example, from shredded used tires which may optionally be PU coated.

Next, in step 104, the liquid mixture is applied onto a base layer 210 (e.g., a concrete layer at the use site where the sports floor is to be installed). The liquid mixture is applied until the desired height is obtained. The height of the e-layer depends on the intended use. Typically, the height of the e-layer is in the range of 8 mm-40 mm. Next, in step 106, the liquid mixture is allowed to solidify. For example, the PU binder can be a liquid one-component (1C) or two-component (2C) PU reaction mixture that solidifies by reacting the PU reaction mixture into a solid PU mass that constitutes the e-layer.

Alternatively, the liquid mixture is generated at a manufacturing plant and is poured in step 108 into one or more molds. The mold can have the shape of a single, long tile or “lane” for generating a molded article that can be rolled up after solidification. Alternatively, one or more molds can have a tile shape that is similar to a square or to a rectangle with sides of more similar length. The molds are adapted for fabricating e-layer tiles. For example, a square-shaped mold can have the dimensions of 100 cm×100 cm×3 cm. Alternatively, the tiles could have the shape of a rectangle wherein one side is 1.1 to 10 times longer than the other side.

In step 110, the liquid mixture is allowed to solidify within the molds into tiles 502.

Finally, the solidified e-layer tiles are removed from the molds, transported to the use site, and laid in step 112 on a base layer 210. In a further step 114, a sports floor, here the artificial turf layer 302, is applied on top of the e-layer. The sports floor can simply be put on top of the e-layer or can be firmly attached to the e-layer by applying an adhesive layer on top of the e-layer and then applying the sports floor onto the adhesive layer. In some embodiments, the e-layer is punched before or after the sports floor layer is applied in order to generate drainage holes for preventing the formation of puddles.

FIG. 2 is a schematic, cross-sectional view of an e-layer 202 that was applied on top of a base layer 210. The e-layer comprises fibers 206 of varying lengths and elastic granules 208. The granules and the fibers are embedded in a binder 204. The diameter of the granules can be, for example, in the range of 1 mm-5 mm. FIG. 2 is for illustration only, and the share of the granules 208 and the fibers 206 in the total volume of the e-layer may not reflect exactly the real situation.

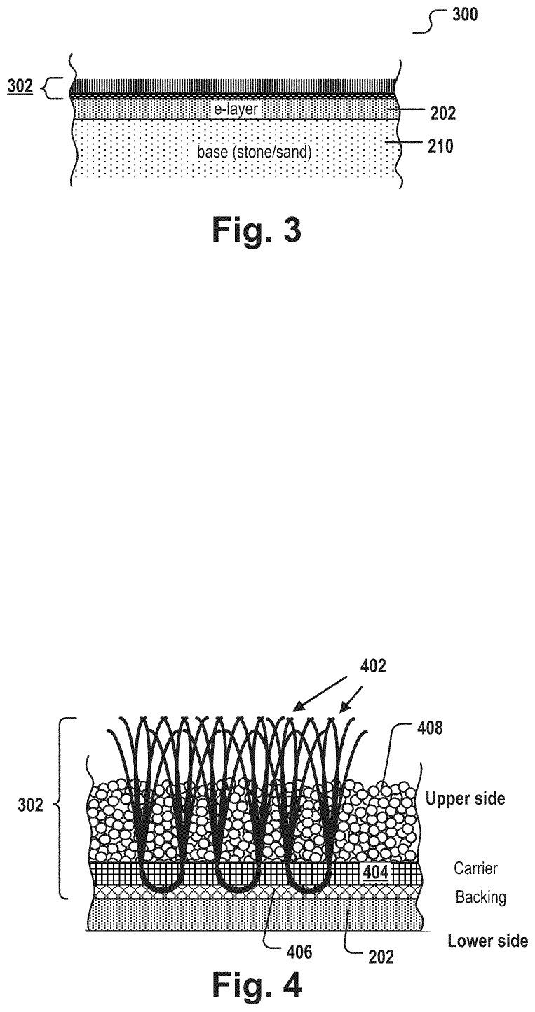

FIG. 3 is a schematic, cross-sectional view of a pavement structure 300 comprising an e-layer 202 as described in greater detail for example with reference to FIG. 2, and a sports floor layer 302.

FIG. 4 is a schematic, cross-sectional view of a pavement structure comprising an e-layer 202 and a sports floor layer 302 in the form of an artificial turf layer. The artificial turf layer 302 comprises a plurality of artificial turf fibers 402 which have been incorporated into a carrier layer 404. For example, the fibers 402 can be polymer fibers, whereby the polymer is polyethylene, polyamide, nylon, polypropylene, or a mixture thereof. The fibers can be incorporated into the carrier (e.g., by tufting, knitting, or weaving). The carrier can be a synthetic fiber mesh or a plant fiber mesh or any other sheet-like structure allowing an incorporation of the artificial turf fibers. Optionally, the artificial turf 302 can comprise a backing 406—e.g., a PU backing layer or a latex layer that incorporates short, U-shaped fiber portions and thereby firmly fixes the fibers in the carrier. In addition, the artificial turf may optionally further comprise an infill layer 408. The infill material can consist of sand and/or elastic granules (e.g., rubber granules or cork granules). The infill granules can be coated. Using an e-layer below the artificial turf may be beneficial as this may allow achieving a desired degree of elasticity without the need to add elastic infill. Alternatively, a comparatively thin infill layer 408 having a height of less than 2 cm, preferably less than 1 cm, may be sufficient to provide a highly elastic artificial turf ground, because the elasticity is already provided by the e-layer. According to some embodiments, the artificial turf 302 does not have a backing or has only a very thin backing having a thickness of less than 2 mm. The backing is commonly applied on the back side of the carrier for fixing the fibers in the carrier and for increasing the elasticity of the artificial turf. According to embodiments of the invention, a sufficient degree of elasticity is already provided by the e-layer, so the thickness of the backing may be reduced or the backing may even be absent. This may reduce the costs of manufacturing the artificial turf layer.

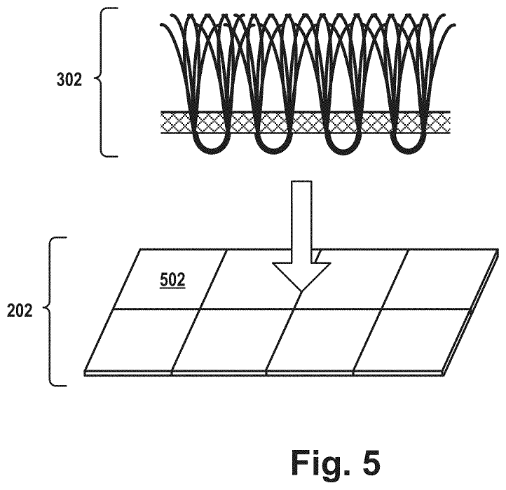

FIG. 5 illustrates the installation of multiple e-layer tiles 502 on a base layer at a use site, thereby providing an elastic support layer 202 for artificial turf. After the installation of the e-layer is completed, the artificial turf is installed on top of the e-layer.

### LIST OF REFERENCE NUMERALS

100-114 steps

202 elastic layer

204 binder

206 fiber

208 elastic granule

210 base layer

300 pavement structure

302 sports floor (artificial turf)

402 artificial turf fibers

404 carrier

406 backing

408 infill layer

502 e-layer tile

1. An elastic layer for use as a support layer of a sports floor, the elastic layer being made of a mixture of fibers, elastic granules, and a binder.

2. The elastic layer of claim 1, wherein the elastic granules are rubber granules, in particular SBR rubber granules and/or EPDM rubber granules.

3. The elastic layer of claim 1, wherein the fibers are non-stretchable.

4. The elastic layer of claim 1, wherein the fibers have a random orientation within the binder.

5. The elastic layer of claim 1, wherein the fibers have a length of at least 1 cm, preferably of at least 2 cm.

6. The elastic layer of claim 1, wherein more than 60% of the fibers have a length of 1-5 cm, preferably 3-4 cm.

7. The elastic layer of claim 1, wherein the fibers have different lengths and wherein preferably the length difference between the length of the shortest 10% of the fibers and the length of the longest 10% of the fibers is at least 3 cm, preferably at least 4 cm.

8. The elastic layer of claim 1, wherein the fibers are plant fibers, in particular jute fibers, hemp fibers, corn silk fibers, flax fibers, bamboo fibers, kapok fibers, sisal fibers, coconut fibers, cotton fibers, cellulose fibers, or mixtures thereof.

9. The elastic layer of claim 1, wherein the fibers are synthetic fibers, in particular polyethylene fibers, polyamide fibers, polypropylene fibers, nylon fibers, polyester fibers, glass fibers, fibers made of rubber, or mixtures thereof.

10. The elastic layer of claim 9, wherein the synthetic fibers comprise unaged or aged artificial turf fibers or artificial turf fiber fragments.

11. The elastic layer of claim 1, wherein the fibers are a mixture of plant fibers and synthetic fibers.

12. The elastic layer claim 1, wherein the sports floor is artificial turf or a playground floor or a floor of a recreational facility.

13. The artificial turf system of claim 1, the fibers comprising synthetic fibers comprising a nucleating agent.

14. The artificial turf system of claim 13, the nucleating agent being be an inorganic substance selected from the group consisting of talcum, kaolin, calcium carbonate, magnesium carbonate, silicate, silicic acid, silicic acid ester, aluminum trihydrate, magnesium hydroxide, meta- and/or polyphosphates, and coal fly ash.

15. The artificial turf system of claim 13, the nucleating agent being an organic substance selected from the group consisting of 1,2-cyclohexane dicarbonic acid salt, benzoic acid, benzoic acid salt, sorbic acid, and sorbic acid salt

16. A floor structure comprising the elastic layer of claim 1 and comprising the sports floor, wherein the sports floor is placed on top of the elastic layer.

17. A method of manufacturing an elastic layer for use as a support layer of sports floor, method comprising:
providing a liquid mixture, the mixture comprising fibers, elastic granules, and a liquid binder;
applying the liquid mixture onto a base layer and allowing the binder to bind for the mixture to solidify; or
filling the liquid mixture into one or more molds, allowing the binder to bind for the mixture to solidify in the one or more molds into respective tiles, and laying the tiles on a base layer.

18. A method of installing a sports floor, the method comprising:
manufacturing the elastic layer in accordance with claim 17; and
placing a sports floor layer on top of the elastic layer.
